(19) United States
(12) Patent Application Publication
(10) Pub. No.: US 2016/0340877 A1
(43) Pub. Date: Nov. 24, 2016

(54) PUSH-BUTTON TYPE MULTI-FUNCTION SHOWER ARM AND METHOD OF MANUFACTURING THE SAME

(71) Applicant: Xiamen Runner Industrial Corporation, Xiamen (CN)

(72) Inventors: Wen-kun Lin, Xiamen (CN); Yuan-shan Liang, Xiamen (CN); Sheng-chao Dai, Xiamen (CN)

(21) Appl. No.: 15/148,443

(22) Filed: May 6, 2016

(30) Foreign Application Priority Data
May 18, 2015 (CN) 201510252010.9

(51) Int. Cl. E03C 1/04; F16K 11/065; E03C 1/06

(52) U.S. Cl. CPC E03C 1/0408; E03C 1/06; F16K 11/065

(57) ABSTRACT

A push-button type multi-function shower arm includes a shower arm main body, provided with a water input end, a shower water output end, and a shower head water output end; a water output chamber, disposed in the shower arm main body, with perimeter of its outer wall disposed with the shower water output end and the shower head water output end in communication with the water output chamber; a shunt valve, disposed in the water output chamber, movable upward and downward, while in a center of the shunt valve is provided with slot channel, to enable communication between the water input end and the shower water output end; and a press device, disposed at top of the shunt valve, to drive the shunt valve to move along axial direction of the water output chamber.

### BACKGROUND OF THE INVENTION

1. Field of the Invention

The present invention relates to a multi-function shower arm, and in particular to a push-button type multi-function shower arm and method of manufacturing the same, used in bathing and sanitary equipment.

2. The Prior Arts

Presently on the market, a shower arm is used only for transporting water when taking a shower, while the devices used for controlling shower water output is put in the place of a mixed valve. In the present installation technology, built-in design is emphasized, such that shower and shower control device are preferred to be designed built-in and integrated together. Also, a water output device is preferred to have its own integrated control element. Yet, presently, user has to purchase water output control device separately for a shower head and a shower, and that could incur additional cost and cause quite inconvenience for the user.

Therefore, presently, the design and performance of the shower arm is not quite satisfactory, and it leaves much room for improvement.

### SUMMARY OF THE INVENTION

In view of the problems and drawbacks of the prior art, the present invention provides a push-button type multi-function shower arm and method of manufacturing the same, to overcome the shortcomings of the prior art.

The present invention provides a push-button type multi-function shower arm, comprising: a shower arm main body, a water output chamber, a shunt valve, and a press device. Wherein, the shower arm main body is provided with a water input end, a shower water output end, and a shower head water output end. The water output chamber is disposed in the shower arm main body, with perimeter of its outer wall disposed with the shower water output end and the shower head water output end in communication with the water output chamber. The shunt valve is disposed in the water output chamber, and is movable upward and downward, while in a center of the shunt valve is provided with slot channel, to enable communication between the water input end and the shower water output end. And the press device is disposed at top of the shunt valve, to drive the shunt valve to move along axial direction of the water output chamber.

In an aspect of the present invention, the press device includes: a core axis, disposed in a center of the shunt valve; a push button, used to press the core axis; and a first rotation axis and a second rotation axis disposed between the core axis and the push button, to press against each other in cooperation. When the push button is pushed to exert a force on the shunt valve, the force exerted is transmitted to the core axis through the first rotation axis and the second rotation axis, while the low rim of the core axis and a mesa of the shunt valve act in cooperation, to force the shunt valve to move along a direction of the force applied.

In another aspect of the present invention, the present invention further includes: a nut and a cap, disposed and sleeved along the first rotation axis and the second rotation axis in sequence from the push button to the shunt valve. The nut is connected to the water output chamber through threads on its inner wall, the water input end is in communication with the shower water output end through the slot channel in the center of the shunt valve, to form a first offshoot channel; while the water input end is in communication with the shower head water output end through a cap between an upper surface of the shunt valve and the cap, to form a second offshoot channel.

In a further aspect of the present invention, the present invention further includes: a cap hat, a shunt valve restoring spring, and a core axis restoring spring. The cap hat is disposed at a side of the shunt valve facing away the push button. The shunt valve restoring spring is disposed on the cap hat, with its one end acting on the cap hat, and with its other end acting on a face of the shunt valve facing the cap hat. And the core axis restoring spring is disposed on the cap hat, and is located in a center of the shunt valve restoring spring, to penetrate the shunt valve, with its one end acting on the core axis, and with its other end acting on the cap hat.

In yet another aspect of the present invention, the present invention further includes: a ratchet mechanism, disposed on and in cooperation with the first rotation axis and the second rotation axis; while guiding ribs are disposed in the cap, to act in cooperation with the ratchet mechanism.

In an aspect of the present invention, the present invention further includes a plurality of tight seal rings, disposed on the core axis.

The present invention also provides a push-button type multi-function shower arm manufacturing method, comprising the following steps:

(1) Providing a shower arm main body, having a water input end, a shower water output end, and a shower head water output end, while a water output chamber is disposed in the shower arm main body, and is in communication with the shower water output end and the shower head water output end; providing a hollow shunt valve, with its center provided with slot channels.

(2) Providing a cap hat, adapted to close the water output chamber, the cap hat and the water output chamber are connected through threads or ultrasonic welding.

The shunt valve is put into the water output chamber, while a shunt valve restoring spring is placed between the shunt valve and the cap hat.

(3) Providing a core axis, and placing it into the shunt valve, with its lower end pressing against the shunt valve, a core axis restoring spring is disposed on the cap hat, with an upper end of the core axis restoring spring acting on the core axis.

(4) Disposing a push button on the upper end of the core axis, to realize direction guidance through disposing a ratchet mechanism on the first transmission axis and the second transmission axis cooperating with each other.

Compared with the Prior Art, the present invention has the advantages that, it combines the conventional shower arm and the water splitter together into one piece. Wherein, a press device is used to achieve the water flow control for the shower arm and a water splitter. It is simple in construction, compact in appearance, and is convenient to operate. Also, it realizes the water level restoration control by itself through utilizing water flow. Moreover, it solves the problem of the user having to purchase and install a shower arm and a water splitter separately, and the ensuing compatibility problem.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is an exploded view of a push-button type multi-function shower arm according to an embodiment of the present invention;

FIG. 2 is a schematic diagram showing a structure of an assembled push-button type multi-function shower arm according to an embodiment of the present invention;

FIG. 3 is a schematic diagram showing a structure of a first rotation axis and a second rotation axis according to an embodiment of the present invention;

FIG. 4 is a schematic diagram showing a push-button type multi-function shower arm in an application (with its shower water output end opened) according to an embodiment of the present invention;

FIG. 5 is a side view of a push-button type multi-function shower arm as shown in FIG. 4 (with its shower water output end opened) according to an embodiment of the present invention; and

FIG. 6 is a schematic diagram showing a push-button type multi-function shower arm in another application (with its push button pressed, and shower head water output end opened) according to another embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

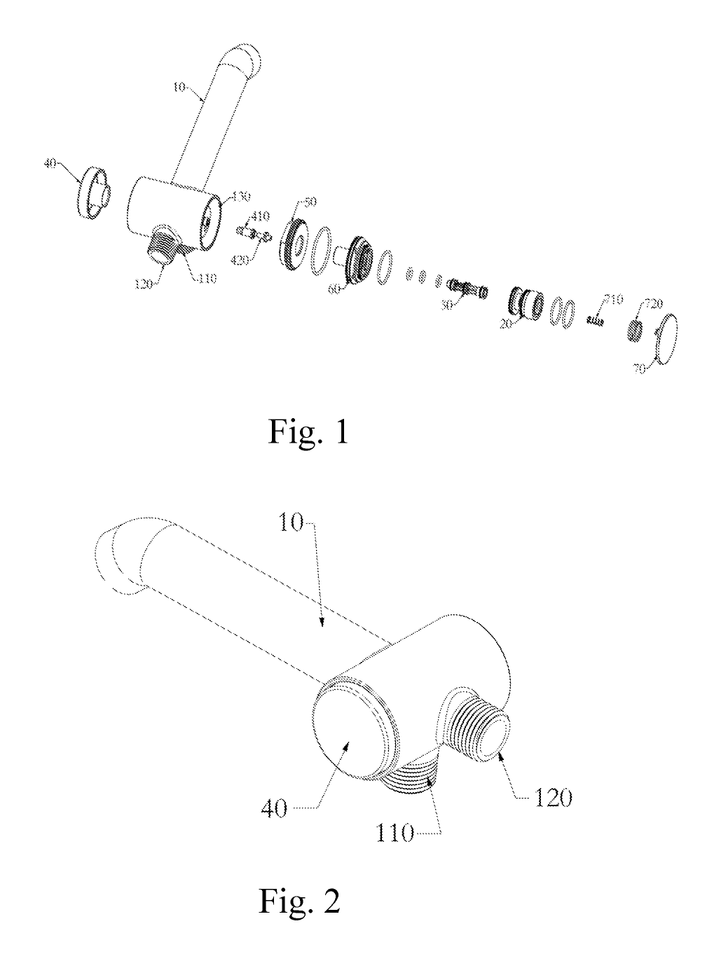

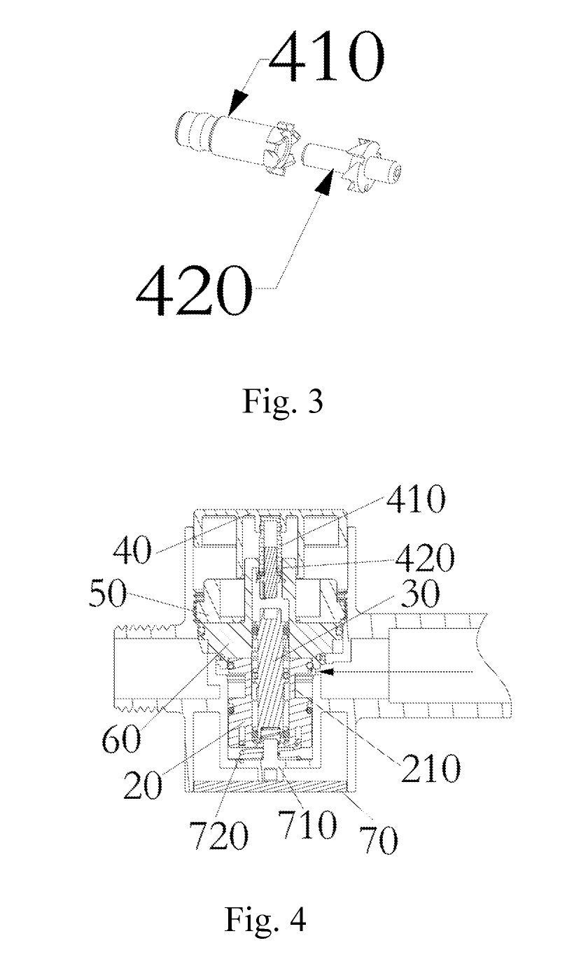

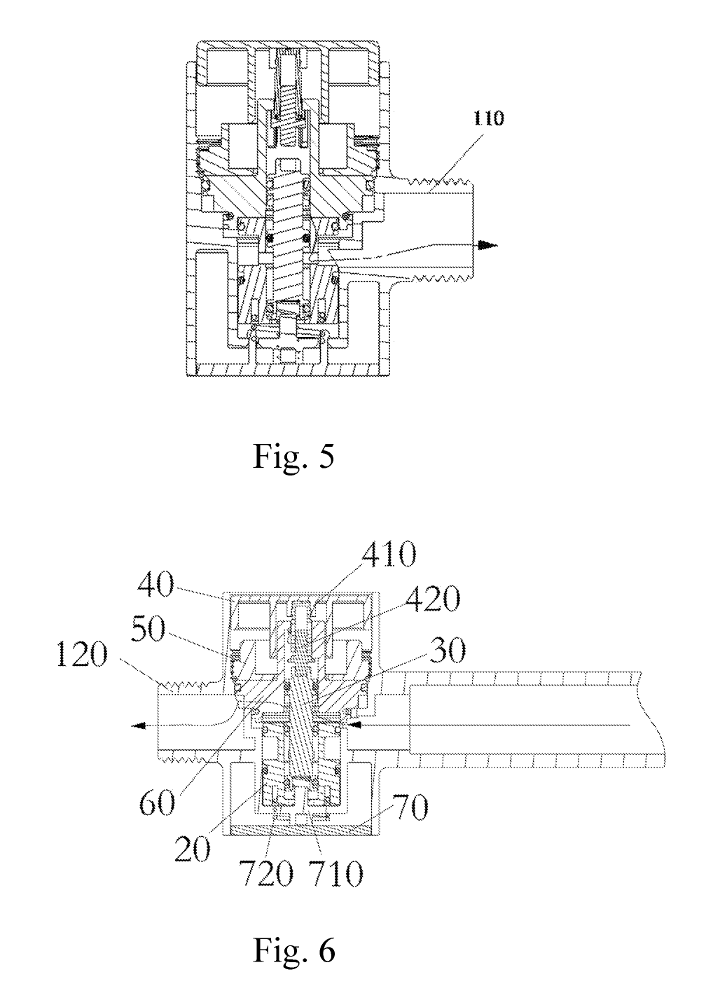

Refer to FIGS. 1 to 6 respectively for an exploded view of a push-button type multi-function shower arm according to an embodiment of the present invention; a schematic diagram showing a structure of an assembled push-button type multi-function shower arm according to an embodiment of the present invention; a schematic diagram showing a structure of a first rotation axis and a second rotation axis according to an embodiment of the present invention; a schematic diagram showing a push-button type multi-function shower arm in an application (with its shower water output end opened) according to an embodiment of the present invention; a side view of a push-button type multi-function shower arm as shown in FIG. 4 (with its shower water output end opened) according to an embodiment of the present invention; and a schematic diagram showing a push-button type multi-function shower arm in another application (with its push button pressed, and shower head water output end opened) according to another embodiment of the present invention.

As shown in FIGS. 1 to 6, the present invention provides a push-button type multi-function shower arm, comprising: a shower arm main body 10, a water output chamber 130, a shunt valve 20, and a press device. Wherein, the shower arm main body 10 is provided with a water input end, a shower water output end 110, and a shower head water output end 120. The water output chamber 130 is disposed in the shower arm main body 10, with perimeter of its outer wall disposed with the shower water output end 110 and the shower head water output end 120 in communication with the water output chamber 130. The shunt valve 20 is disposed in the water output chamber 130, that is movable upward and downward, while in a center of the shunt valve 20 is provided with slot channel 210, to enable communication between the water input end and the shower water output end 110. And the press device is disposed at top of the shunt valve 20, to drive the shunt valve 20 to move along axial direction of the water output chamber 130.

In an embodiment of the present invention, the press device includes: a core axis 30, disposed in a center of the shunt valve 20; a push button 40, used to press the core axis 30; and a first rotation axis 410 and a second rotation axis 420 disposed between the core axis 30 and the push button 40, to press against each other in cooperation. When the push button 40 is pushed to exert a force on the shunt valve 20, the force exerted is transmitted to the core axis 30 through the first rotation axis 410 and the second rotation axis 420, while the low rim of the core axis 30 and a mesa of the shunt valve 20 act in cooperation, to force the shunt valve 20 to move along a direction of the force applied.

In an embodiment of the present invention, the present invention further includes: a nut 50 and a cap 60, disposed and sleeved along the first rotation axis 410 and the second rotation axis 420 in sequence from the push button 40 to the shunt valve 20. The nut 50 is connected to the water output chamber 130 through threads on its inner wall, the water input end is in communication with the shower water output end 110 through the slot channel 210 in the center of the shunt valve 20, to form a first offshoot channel; while the water input end is in communication with the shower head water output end 120 through a cap between an upper surface of the shunt valve 20 and the cap 60, to form a second offshoot channel.

In an embodiment of the present invention, in order to achieve position restoration, the present invention further includes: a cap hat 70, a shunt valve restoring spring 720, and a core axis restoring spring 710. Wherein, the cap hat 70 is disposed at a side of the shunt valve 20 facing away the push button 40. The shunt valve restoring spring 720 is disposed on the cap hat 70, with its one end acting on the cap hat 70, and with its other end acting on a face of the shunt valve 20 facing the cap hat 70. And the core axis restoring spring 710 is disposed on the cap hat 70, and is located in a center of the shunt valve restoring spring 720, to penetrate the shunt valve 20, with its one end acting on the core axis 30, and with its other end acting on the cap hat 70.

In an embodiment of the present invention, the present invention further includes: a ratchet mechanism, disposed on and in cooperation with the first rotation axis 410 and the second rotation axis 420; while guiding ribs are disposed in the cap 60, to act in cooperation with the ratchet mechanism. In the present embodiment, the ratchet mechanism is used to achieve direction guidance and position restriction through pressing the push button.

In an embodiment of the present invention, the present invention further includes a plurality of tight seal rings, disposed on the core axis 30, to ensure tight seal.

In application, as shown in FIGS. 4 to 6, the arrow indicates the direction of water flow. In the beginning, the water input end is in communication with the shower water output end 110 through the slot channel 210 in the center of the shunt valve 20, to form a first offshoot channel. In case water is input, the pressure of water flows in overcomes the tension of the shunt valve restoring spring 720, so that water can flow through. When the push button 40 is pressed to overcome the pressure of the water flowing through, the shunt valve 20 is moved downward, so water flows through above the shunt valve 20, to realize a second offshoot channel formed by means of the water input end communicating with the shower head water output end 120 through a gap between an upper surface of the shunt valve 20 and the cap 60. When the push button 40 is released, the core axis restoring spring 710 will bring the core axis 30 to move upward, in case the water is closed at the water input end, the pressure of water flow disappears, so that the shunt valve 20 will restore to its original position.

The present invention also provides a push-button type multi-function shower arm manufacturing method, comprising the following steps:

(1) Providing a shower arm main body 10, having a water input end, a shower water output end 110, and a shower head water output end 120, while a water output chamber 130 is disposed in the shower arm main body 10, and is in communication with the shower water output end 110 and the shower head water output end 120; providing a hollow shunt valve 20, with its center provided with slot channels.

(2) Providing a cap hat 70, adapted to close the water output chamber 130, the cap hat 70 and the water output chamber 130 are connected through threads or ultra sonic welding. The shunt valve 20 is put into the water output chamber 130, while a shunt valve restoring spring 720 is placed between the shunt valve 20 and the cap hat 70.

(3) Providing a core axis 30, and placing it into the shunt valve 20, with its lower end pressing against the shunt valve 20, a core axis restoring spring 710 is disposed on the cap hat 70, with an upper end of the core axis restoring spring 710 acting on the core axis 30.

(4) Disposing a push button 40 on the upper end of the core axis 30, to realize direction guidance through disposing a ratchet mechanism on the first transmission axis and the second transmission axis cooperating with each other.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A push-button type multi-function shower arm, comprising:
a shower arm main body, provided with a water input end, a shower water output end, and a shower head water output end;
a water output chamber, disposed in the shower arm main body, with perimeter of its outer wall disposed with the shower water output end and the shower head water output end in communication with the water output chamber;
a shunt valve, disposed in the water output chamber, movable upward and downward, while in a center of the shunt valve is provided with slot channel, to enable communication between the water input end and the shower water output end; and
a press device, disposed at top of the shunt valve, to drive the shunt valve to move along axial direction of the water output chamber.

2. The push-button type multi-function shower arm as claimed in claim 1, wherein the press device includes:
a core axis, disposed in a center of the shunt valve; a push button, used to press the core axis, and a first rotation axis and a second rotation axis disposed between the core axis and the push button, to press against each other in cooperation, such that when the push button is pushed to exert a force on the shunt valve, the force exerted is transmitted to the core axis through the first rotation axis and the second rotation axis, while the low rim of the core axis and a mesa of the shunt valve act in cooperation, to force the shunt valve to move along a direction of the force applied.

3. The push-button type multi-function shower arm as claimed in claim 2, further comprising:
a nut and a cap, disposed and sleeved along the first rotation axis and the second rotation axis in sequence from the push button to the shunt valve, such that the nut is connected to the water output chamber through threads on its inner wall, the water input end being in communication with the shower water output end through the slot channel in the center of the shunt valve, to form a first offshoot channel, while the water input end is in communication with the shower head water output end through a cap between an upper surface of the shunt valve and the cap, to form a second offshoot channel.

4. The push-button type multi-function shower arm as claimed in claim 3, further comprising:
a cap hat, disposed at a side of the shunt valve facing away the push button;
a shunt valve restoring spring, disposed on the cap hat, with its one end acting on the cap hat, and with its other end acting on a face of the shunt valve facing the cap hat; and
a core axis restoring spring, disposed on the cap hat, and located in a center of the shunt valve restoring spring, to penetrate the shunt valve, with its one end acting on the core axis, and with its other end acting on the cap hat.

5. The push-button type multi-function shower arm as claimed in claim 3, further comprising:
a ratchet mechanism, disposed on and in cooperation with the first rotation axis and the second rotation axis; while guiding ribs are disposed in the cap, to act in cooperation with the ratchet mechanism.

6. The push-button type multi-function shower arm as claimed in claim 2, further comprising:
a plurality of tight seal rings, disposed on the core axis.

7. A manufacturing method used to produce a push-button type multi-function shower arm as claimed in claim 1, comprising following steps:
(1) providing a shower arm main body, having a water input end, a shower water output end, and a shower head water output end, while a water output chamber is disposed in the shower arm main body, and being in communication with the shower water output end and the shower head water output end; providing a hollow shunt valve, with its center provided with slot channels;
(2) providing a cap hat, adapted to close the water output chamber, the cap hat and the water output chamber are connected through threads or ultra sonic welding, the shunt valve being put into the water output chamber, while a shunt valve restoring spring is placed between the shunt valve and the cap hat;
(3) providing a core axis, and placing it into the shunt valve, with its lower end pressing against the shunt valve, a core axis restoring spring being disposed on the cap hat, with an upper end of the core axis restoring spring acting on the core axis; and
(4) disposing a push button on the upper end of the core axis, to realize direction guidance through disposing a ratchet mechanism on the first transmission axis and the second transmission axis cooperating with each other.
